(19) United States
(12) Patent Application Publication
(10) Pub. No.: US 2016/0335714 A1
(43) Pub. Date: Nov. 17, 2016

(54) RELISTING PHYSICAL AUCTION ITEMS AT A NETWORKED MARKETPLACE

(71) Applicant: eBay Inc., San Jose, CA (US)

(72) Inventors: Gayathri Ravichandran Geetha, Sunnyvale, CA (US); Harita Yenisetty, Sunnyvale, CA (US); Bhavani Kumar Hari, Campbell, CA (US); Prashanth Patlolla, San Jose, CA (US)

(21) Appl. No.: 14/712,764

(22) Filed: May 14, 2015

(51) Int. Cl. G06Q 30/08; G06Q 30/02

(52) U.S. Cl. CPC G06Q 30/08; G06Q 30/0283

(57) ABSTRACT

In various example embodiments, a system and method for profit taking in a networked marketplace are presented. A method includes determining a price estimate that an item will sell for at a networked marketplace, directing purchase of the item at a remote auction by displaying a maximum purchase price to a user at the remote auction, listing the item in a listing at the networked marketplace, and sending a message to a seller of the remote auction, the message directing the seller to ship the item to the purchaser.

### TECHNICAL FIELD

Embodiments of the present disclosure relate generally to data processing and, more particularly, but not by way of limitation, to relisting physical auction items via a networked marketplace.

### BACKGROUND

The final price of an item at a physical auction is a function of many factors. The number of bidders, the experience level of the bidders, location of the auction house, item marketing, availability of similar items in the local marketplace, limited access a remote population of bidders, and other factors all affect the final bid price for an item at a physical auction house. Lack of knowledge regarding the actual value of auction items can lead to differences between the price paid for an item and the price of the item if offered in a networked marketplace.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating an example of a system that may be installed on a machine, according to an example embodiment.

FIG. 3 is a diagram illustrating use of a system, according to an example embodiment.

FIG. 4 is a diagram illustrating a system interacting with a physical auction, according to an example embodiment.

FIG. 5 is a diagram illustrating combining multiple items into a single set for relisting in a networked marketplace, according to one example embodiment.

FIG. 6 is a diagram illustrating an item comprising multiple parts according to one example embodiment.

FIG. 7 illustrates a relationship between a number of bids on an item over a period of time, according to one example embodiment.

FIG. 8 illustrates a relationship between a number of bidders on an item and the price of the item, according to one example embodiment.

FIG. 9 is a flow diagram illustrating a method of the system, according to some example embodiments.

FIG. 10 is a flow diagram illustrating an example method for relisting physical auction items at a networked marketplace, according to one example embodiment.

FIG. 11 is a flow diagram illustrating another example method of relisting physical auction items at a networked marketplace, according to some example embodiments.

FIG. 12 is a flow diagram illustrating one example of relisting physical auction items at a networked marketplace, according to some example embodiments.

FIG. 13 is a flow diagram illustrating an example of another method of the system, according to some example embodiments.

FIG. 14 is a diagram illustrating an example user interface on a personal electronic device, according to an example embodiment.

FIG. 15 is a block diagram illustrating an example of a software architecture that may be installed on a machine, according to some example embodiments.

FIG. 16 illustrates a diagrammatic representation of a machine, in the form of a computer system, within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, a computer system determines a price estimate that an item (e.g. an item available at a remote physical auction) will sell for in a networked marketplace. In an example, the price of the item is based on a threshold number of bids at the networked marketplace being above the price estimate. Other factors include but are not limited to, the condition of the item, the value of an offer to purchase the item from a buyer at the networked marketplace, or other factors.

In another example, the system directs purchase of a set of items at a remote physical auction and lists the set at the networked marketplace. In this example, the system determines the price of the respective items in the set based on the value of the set at the networked marketplace. In one example, the system determines the price of an item based, at least in part, on the respective values of distinct and identifiable sub-parts of the item.

In an embodiment, directing purchase of an item at a physical auction includes displaying a maximum value for the item at the networked marketplace to a user at the physical auction. In another embodiment, directing purchase of the item includes displaying, or causing to be displayed, a bid for the item. For example, the system may participate in the physical auction by displaying a bid for the item.

In another embodiment, the system sends a message to the seller of the item at the physical marketplace that the item has been relisted at the networked marketplace. The system may then request, in response to a buyer purchasing the item at the networked marketplace, that the seller ship the item to the buyer. Thus, possession of the item may not transfer to the buyer of the item at the physical marketplace, but may transfer directly from the seller of the item at the physical marketplace to the buyer of the item at the networked marketplace. Such a scenario allows a user of the system to profit based on a price difference between purchase of the item at the physical marketplace and sale of the item at the networked marketplace.

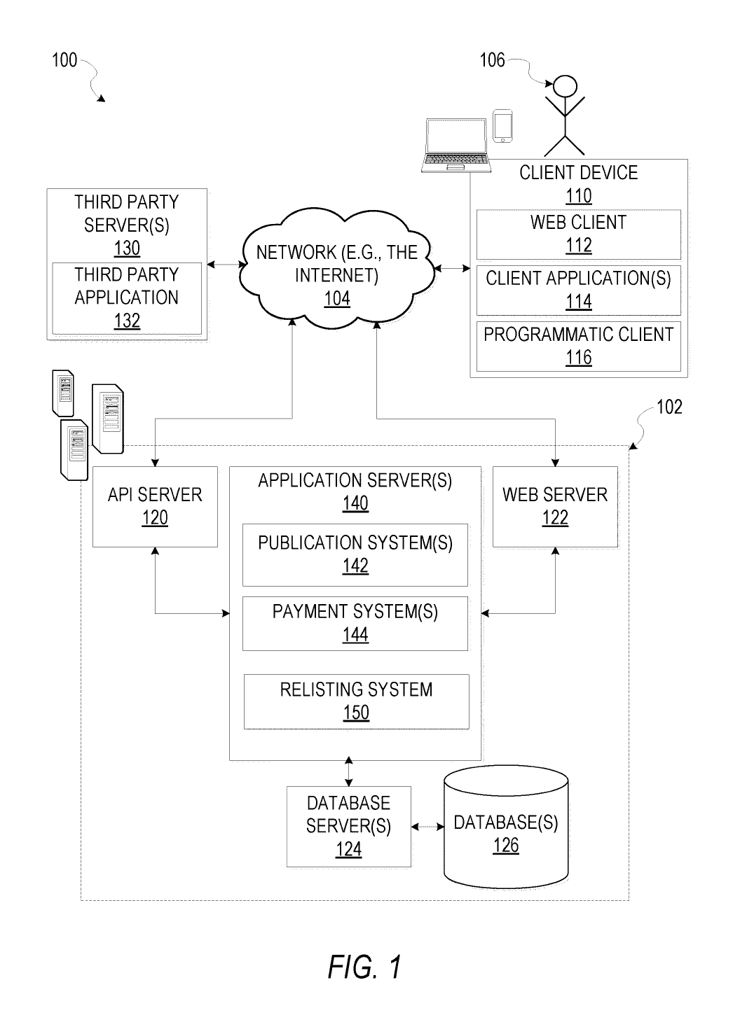

FIG. 1 is a block diagram illustrating a networked system, according to some example embodiments. A networked system 102, in the example forms of a networked marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), a client application 114, and a programmatic client 116 executing on client device 110.

The client device 110 may comprise, but is not limited to, a mobile phone, laptop, portable digital assistants (PDAs), smart phones, tablets, ultra books, netbooks, laptops, multi-processor systems, microprocessor-based or programmable consumer electronics, or any other communication device that a user may utilize to access the networked system 102. In some embodiments, the client device 110 may include a display module (not shown) to display information (e.g., in the form of user interfaces). The client device 110 may be a device of a user that is used to perform a transaction involving digital items within the networked system 102. In one embodiment, the networked system 102 is a networked marketplace that responds to requests for product listings, publishes publications comprising item listings of products available on the networked marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user 106, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

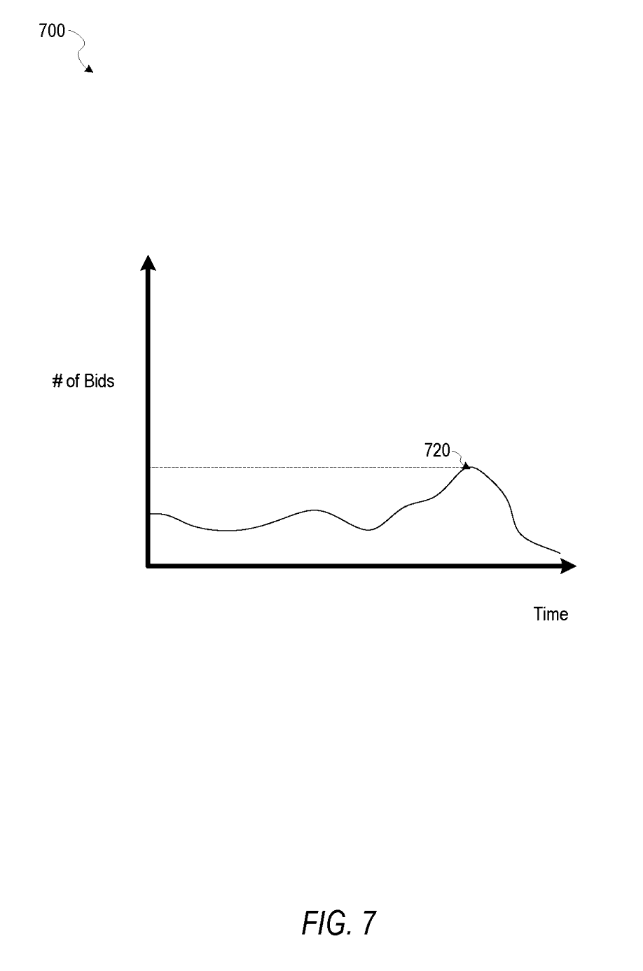

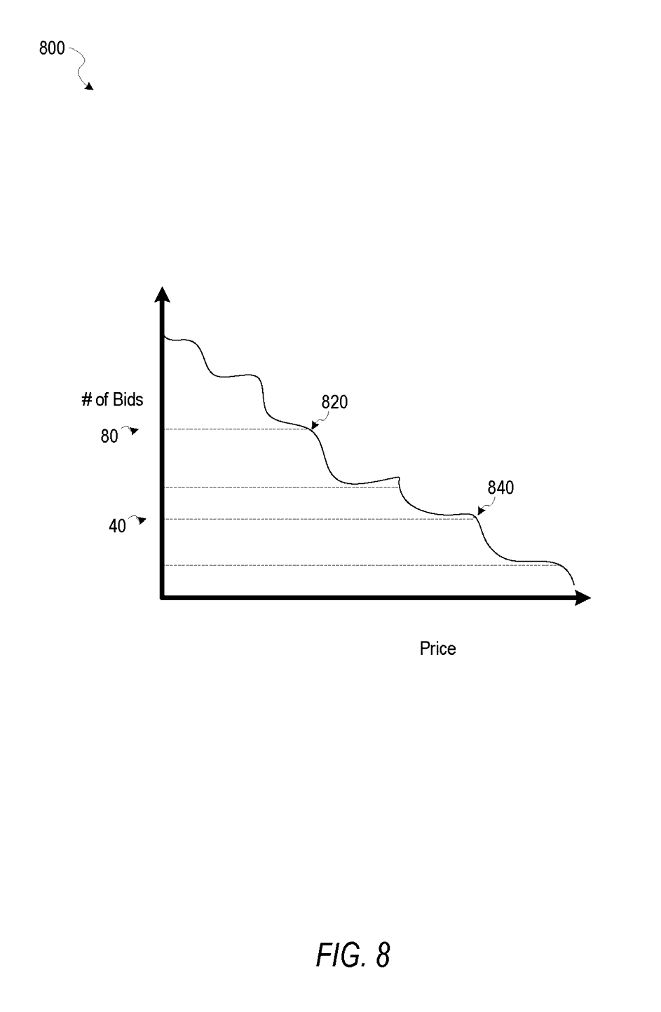

The relisting system 150 may provide functionality operable to perform various transactions as described herein. The relisting system 150 may store a determined price, identification of an item, and/or any other information via the database server 124. The relisting system 150 may also communicate with one or more application servers 140 to determine bid counts and prices for items being sold at the networked system 102. Various price relationships are described in FIG. 7 and FIG. 8.

Further, while the client-server-based network architecture 100 shown in FIG. 1 employs a client-server architecture, the present inventive subject matter is, of course, not limited to such an architecture, and could equally well find application in a distributed, or peer-to-peer, architecture system, for example. The various publication system 142, payment system 144, and relisting system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

Additionally, a third party application(s) 132, executing on a third party server(s) 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

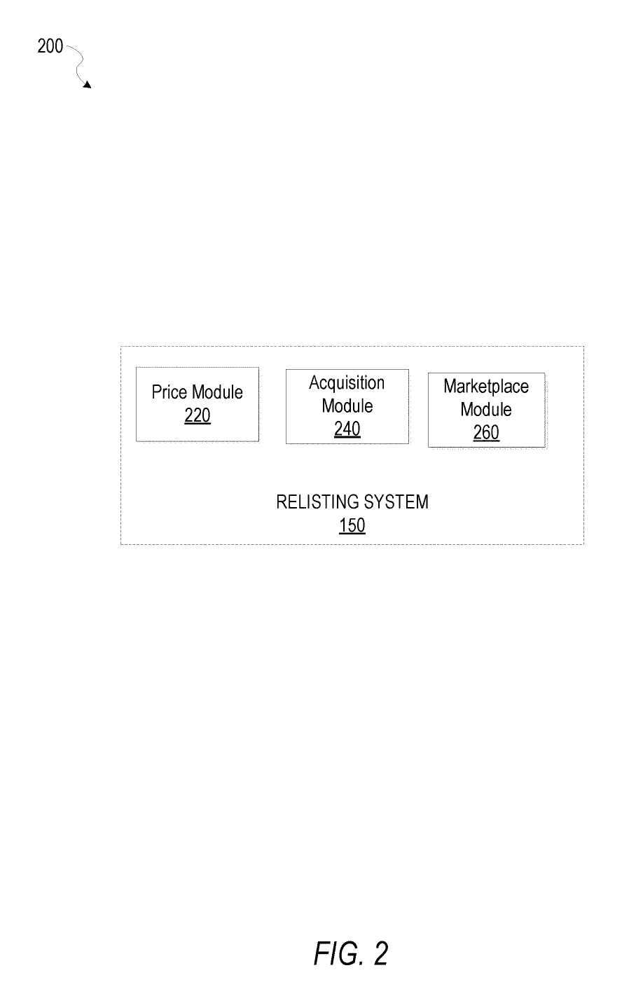

FIG. 2 is a block diagram illustrating an example 200 of the relisting system 150 that may be installed on a machine, according to an example embodiment. In one example embodiment, the relisting system 150 is configured as a programmatic client 116 and includes a price module 220, an acquisition module 240, and a marketplace module 260.

In one embodiment, the price module 220 estimates a price that an item will sell for at a networked marketplace. In a specific example, the item is available at a remote physical auction. A remote physical auction includes, at least, a physical location for selling items via an auction. At a physical auction, users 106 present at the physical auction present bids with a highest bidder winning the item.

In an embodiment, the price estimate is based upon information from a similar item at the networked marketplace receiving a threshold number of bids above the price estimate. For example, where a threshold number of bids is 100 bids, and 100 bidders bid more than $100 for a similar item at the networked marketplace, the price module 220 determines that the price estimate is $100. In another embodiment, the price estimate is based on the condition of the item where the condition of the item can be selected from a set of predefined conditions, as will be further described.

In certain embodiments, the threshold number of bids is received from a user. Of course, a user may prefer a higher number of bids to increase likelihood that the item will sell for the estimated price. A more risky user may prefer a smaller number of threshold bids. Of course, any number of threshold bids may be used and this disclosure is not limited in this regard.

In an embodiment, the price module 220 determines a price estimate that an item will sell for at a networked marketplace based on previous sales of like items at the networked system 102. In an embodiment, the item can be available for purchase at a remote auction. In an example, a remote auction can be a physical auction house, an antique shop, or any other location engaged in the purchase or sale of useful goods.

In an embodiment, the price module 220 determines a price estimate that an item will sell for at a networked marketplace based on a threshold number of bids made on like items at the networked system 102. For example, where a like item at the networked marketplace receives one bid above $900 and thirty bids above $500, in response to the threshold number of bids being 30 bids, the price module 220 determines that the price estimate is $500 because more than 30 bids exceeded $500.

In an embodiment, the price module 220 determines a price estimate that an item will sell for at a networked system 102 based on the condition of like items at the networked system 102. In an example, the conditions of like items are parameters that can include quantitative or qualitative parameters. For example, quantitative parameters can include, but are not limited to, use-state descriptors (e.g., “new”, “used”) or item descriptors (e.g., model numbers, part numbers). In an example, qualitative parameters can include, but are not limited to, condition descriptors (e.g., “good”, “poor”, “in need of repair”).

In an example, quantitative or qualitative parameters are used as part of a weighting function to determine a price of an item 242, based on the condition of like items at the networked system 102. In an example, the weighting function can assign discrete values on a numerical scale. For example, a condition descriptor of “in need of repair”, “poor” or “good,” “new”, or the like, can correspond via a weighting function with discrete values of “0.5,” or “1.0,” “2.0,” and “4.0” respectively that can be multiplied with a value to determine the estimated price based on the condition of the item 242. In other embodiments, the weighting function

In an embodiment, the price module 220 determines a price estimate that an item 242 will sell for at a networked system 102 based on the value of an offer to purchase the item 242 where the offer is received from a buyer at the networked system 102. In one example, the networked system 102 includes a reverse auction for the item 242 where a price for the reverse auction is $200. In response, the price module 220 determines that a price for the item 242 the networked system 102 is $200. In an example, the price module 220 can compare a first price estimate with a second price estimate to determine a highest price estimate. For example, where the price module 220 determines a first price estimate of $300, based on a threshold number of bids for a like item exceeding a price, and determines a second price estimate of $320, based on an offer to purchase the item from a buyer in the networked marketplace, the price module 220 may select the highest price estimate (e.g. the $320).

In an embodiment, the price module 220 determines an estimated price that an item will sell for at a networked system 102 where the price estimate includes estimating a price for a set of items that includes the item 242. In an example, a set of items can include one or more items that work in concert to perform a task. In certain examples, the item includes many distinct identifiable parts. As described herein, distinct identifiable parts include, but is not limited to, components of an item that may be disassembled using ordinary tools, as one skilled in the art may appreciate. In one example, where a simple screw driver may disassemble at item such that the distinct parts are not physically connected, but may be reassembled, the price estimate of the item may include the various distinct identifiable parts. In another example, where the distinct identifiable parts have been assigned part numbers from a manufacturer they may be distinctly identifiable. Of course, this disclosure is not limited in this regard.

According to one specific example, estimating the price of a bicycle includes estimating the price of individual components of the bicycle including, but not limited to, the frame, the wheels, and the handlebars and summing estimated prices of the distinct and identifiable components to estimate a price of the bicycle. In another embodiment, the price module 220 determines a highest estimated price by comparing the value of the assembled item with the value of the respective identifiable parts and determining the estimated price to be the higher of the two values.

In an example, a set of items can include one or more items that are grouped yet do not perform a task. For example, estimating the price of the contents of an abandoned storage locker can include estimating the price of individual items contained in the abandoned storage locker and summing the prices of the individual components to determine a total price estimate for the items in the locker.

In one embodiment, the acquisition module 240 directs the purchase of the item at the remote auction. In an embodiment, the acquisition module 240 can direct the purchase by displaying a maximum purchase price to a user 106 at the remote auction 250. In an example, the maximum purchase price can be a threshold percentage below the price estimate. For example, in response to the price module 220 determining that an item would sell for $100 at the networked system 102 and, in response to the user 106 indicating desire for a 10% profit, the acquisition module 240 indicates that a maximum bid for the item at a physical auction is $90.

In an embodiment, the acquisition module 240 can direct the purchase of an item 242 by displaying a bid using a display at the remote auction 250. In an example, the bid is above a current bid for the item and below the maximum purchase price.

As one skilled in the art may appreciate, the physical auction may provide an electronic interface for the relisting system 150. In this example, the acquisition module 240 may communicate with this interface to determine which items are available as well as quantitative or qualitative parameters for the current item as previously described.

In another embodiment, the acquisition module 240 directs the purchase of an item by directing the purchase of several items so that the item is formed by a set of items. In one example, the several items may be at different physical auctions, but of course, this is not necessarily the case. In an example, a set of items can include one or more items that work in concert to perform a task. For example, coordinating the purchase of several items can include, but is not limited to, displaying a maximum purchase price for individual items to a user 106 at the remote auction 250 and displaying a bid for individual items using a display at the remote auction 250 as previously described.

In one embodiment, the marketplace module 260 supervises the resale of the item purchased at the remote auction 250. In an embodiment, the marketplace module 260 can list the item in a listing and assign a listing price to the item at the networked marketplace operating at the networked system 102. In an example, the listing of the item is in response to receiving an indicator indicating that the user 106 won the remote auction 250. In an example, the listing price can be at or above the price estimate.

In an embodiment, the marketplace module 260 sends a message to a seller of the item at the remote auction 250 directing the seller to ship the item to the purchaser. In an example, the purchaser purchased the item 342 at the networked marketplace (e.g. networked system 102). In an embodiment, the marketplace module 260 can send a message on behalf of the user 106 to a seller of the item 242 at the remote auction 250 directing the seller to ship the item to a purchaser of the item at the networked marketplace (e.g. networked system 102).

In an embodiment, the marketplace module 260 sends a message to the seller of the item 242 to request to delay transfer of the item from the seller to the user 106 until the listing completes. In the event a listing does sell within a threshold period of time, such as, but not limited to, 24 hours, the marketplace module 260 sends a message to the seller of the item at the physical marketplace to transfer the item to the buyer of the item at the networked system 102. In the event that the listing does not sell within a threshold period of time, the marketplace module 260 may relist the item until it does sell.

In another embodiment, the marketplace module 260 sends a message to the seller of the item 242 at the physical marketplace, wherein the message identifies the expected profit resulting in listing the item at the networked marketplace. In one example, the message offers the seller a percentage of the profits in exchange for the seller delaying transferring possession of the item to the user 106. The marketplace module 260, according to this example, receives a response from the seller. If, in their response, the seller agrees to delay transfer of the item, the marketplace module 260 transfers a percentage of the profits to the seller.

In one specific example, the price module 220 determines an estimated price for an exotic bottle of perfume to be $800. The acquisition module 240 directs purchase of the bottle of exotic perfume at a physical auction and wins the bottle of perfume for $680. In response to the seller agreeing to delay shipping the perfume to the user 106, and the perfume selling at the networked marketplace for $800, the marketplace module 260 may transfer 33% of the profits (e.g. 33% of $120) or $40 to the seller at the physical marketplace. Therefore, according to this example, the user 106 and the seller both profit from the resale of the perfume at the networked marketplace.

In another embodiment, in response to the acquisition module 240 directing purchase of a set of items, the marketplace module 260 lists the set of items in a single listing at the networked marketplace. Therefore, according to certain examples, the system 150 takes profits at a networked marketplace by acquiring various items of a set in different physical auctions and selling the assembled set at the networked marketplace. Furthermore, as previously described, the system 150 may share the profits with distinct sellers of the various items.

In another embodiment, the price module 220 determines the price of an item 242 based on price estimates of the distinct identifiable parts of the item 242. In response to the acquisition module 240 directing purchase of the item 242, the marketplace module 260 creates separate and distinct listings for each of the distinct parts at the networked marketplace.

In another embodiment, the marketplace module 260 lists the item(s) 242 at the networked system 102 according to a determination by the price module 220. For example, in response to the price module 220 determining that a higher price may be received for the item 242 by listing the item 242 as a whole, the marketplace module 260 lists the item 242 as a whole at the networked marketplace. In another example, in response to the price module 220 determining that a higher price may be received for the item 242 by listing the distinct identifiable parts in separate listings, the marketplace module 260 relists the distinct identifiable parts, according to the price estimate.

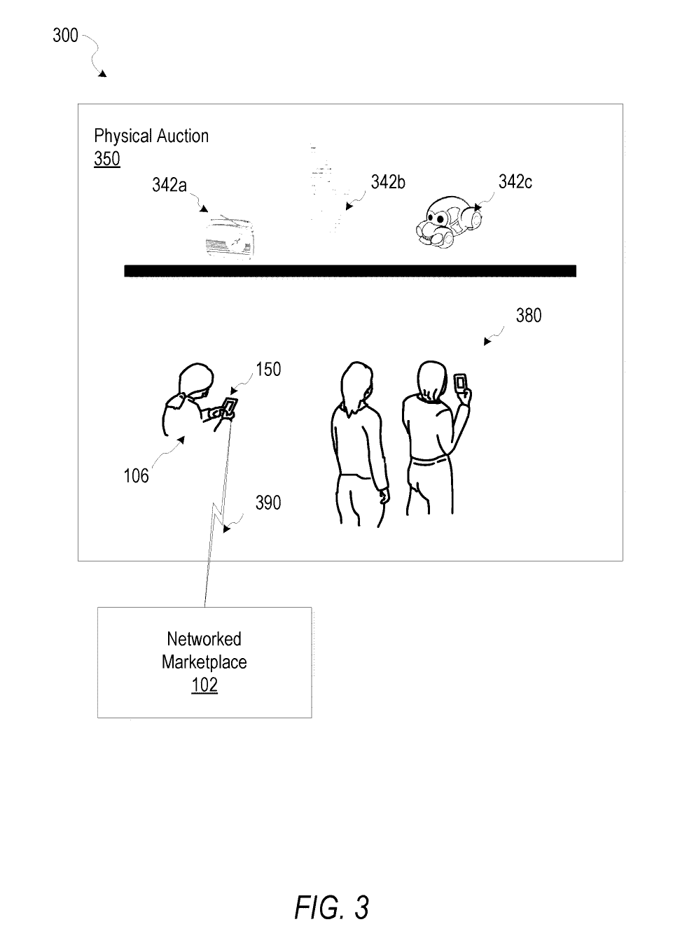

FIG. 3 is a diagram illustrating use of the relisting system 150, according to an example embodiment. In contrast to an on-line auction, a physical auction 350 allows bidders 380 and others to inspect and physically interact with items 342 at the physical auction 350.

Prior to the beginning of bidding for each item, the price module 220 transmits a price estimate to the user 106. The price estimate may also include a maximum bid price based on a threshold profit percentage indicated by the user 106. In this way, the user 106 is put in a position of knowing the respective values of the items 342 and potential profits to be made at the networked system 102.

In an embodiment, the relisting system 150 displays a maximum purchase price. In an example, the maximum purchase price is the price that will allow the user 106 to realize a certain amount of profit when the item 342 is relisted and sold in a separate auction on a networked system 102. For example, the maximum purchase price can be a threshold percentage below the price estimate. In another embodiment, the amount of profit is a fixed amount. Accordingly, the relisting system 150 estimates a price based on the fixed amount of profits requested by a user.

In one example, the price module 220 receives a request from the user 106 for a price estimate for item 342a. The price module 220 transmits the price estimate to the user 106 over the connection 390. In response, the user 106 bids on the item 342 knowing the price the item 342a will likely sell for at the networked marketplace 102.

In response to winning the auction, the acquisition module 240 receives an indicator from the user 106 that the user 106 won the auction. The marketplace module 260 then relists the item at the networked marketplace 102, using information received either from a user at the physical auction, or from an electronic interface to the physical auction as described herein. The acquisition module 240 may notify the user 106 in response to a buyer purchasing the item at the networked marketplace 102. In other embodiments, the user 106 may bid on items 342a, 342b, and 342c concurrently, based, at least in part, on an auction format for the physical auction 350.

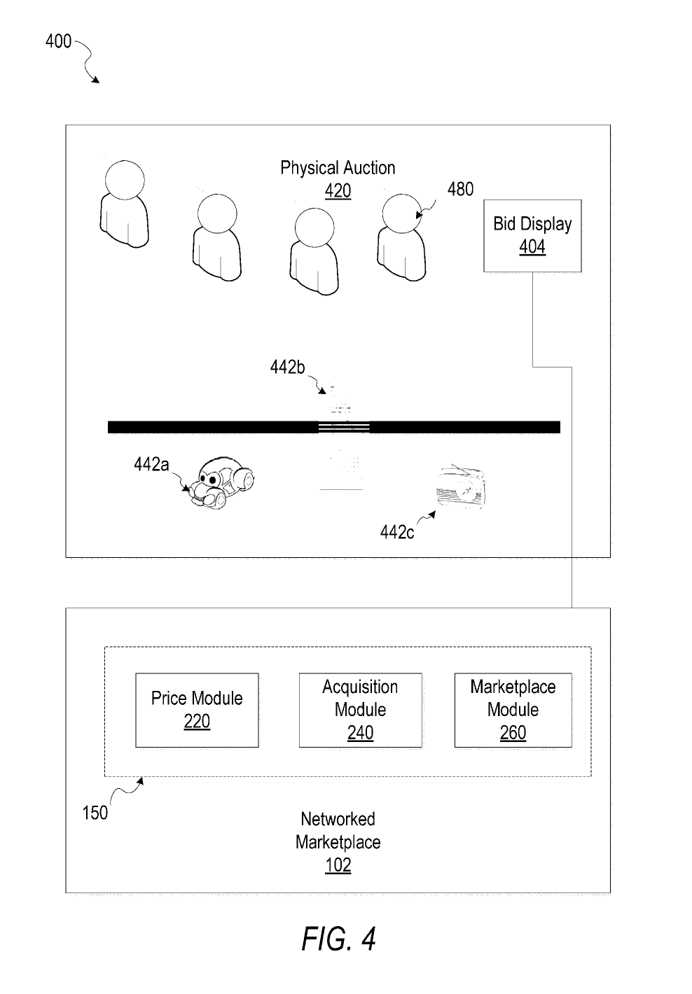

FIG. 4 is a diagram illustrating the relisting system 150 interacting with a physical auction, according to an example embodiment. The relisting system 150 can be used to participate in a physical auction 420 with other bidders 480. In an example, participation can include bidding on items 442 at the physical auction 420 where the relisting system 150 is present at or remote from the physical auction 420.

In an embodiment, the relisting system 150 is configured to electronically communicate with the physical auction 420. In one example, a server for the physical auction 420 provides information from the physical auction 420 including, but is not limited to, the item up for bid, a condition for the item, an image of the item, a part number for the item, an identifying term for the item, item properties and/or characteristics, the current bid price, the identity of the current bidder 380, an indicator indicating a successful bid, or other facts pertaining to the items for bid or the bidding process, as one skilled in the art may appreciate. The server for the physical auction 420 may also provide registration to allow the acquisition module 240 to authenticate as a valid bidder 680 for items 442 at the auction and ensure that bids displayed via the display 404 are valid and binding. In another embodiment, a user at the physical auction transmits the information using a user interface provided at the client device 110. Of course, one skilled in the art may recognize other ways in which the relisting system 150 may receive information regarding an item up for auction at the physical auction and this disclosure is not limited in this regard.

According to one embodiment, the price module 220 estimates a price for the item that is current being auctioned and the acquisition module 240 displays incremental bids to win the auction up to a threshold profit percentage below the price estimate. In this way, the acquisition module 240 participates in a live auction at the physical auction 420.

In one example, the item 442b is currently up for auction. One or more bidders 480 may display bids for the item 442b according to their respective interest. The price module 220 determines an estimated price for the item 442b as $1,140. Based on an indicator from the user 106, the acquisition module 240 receives a profit percentage representing a profit estimate indicated preferred by the user 106. The profit percentage at least includes, but is not limited to, a percentage of the price estimate that the user 106 expects to receive as profit for reselling the item 442b at the networked 102. For example, the acquisition module 240 may receive a profit percentage of 12% from the user 106. Accordingly, the acquisition module 240 bids on the auction for the item 442b in incremental bids up to $1003 (e.g. 88% of $1,140).

In response to receiving an indicator that the acquisition module 240 won the auction, the marketplace module 260 generates a listing for the item 442b. In one example, the marketplace module 260 may generate a listing where a buyer may purchase the item 442b immediately (e.g. without waiting for other bidders 480 of the virtual auction to end). In another example, the marketplace module 260 may create a listing for the item 442b where the auction price begins at the estimated price. In this specific example, the marketplace module 260 creates a listing for the item 442b with a starting price of $1,140.

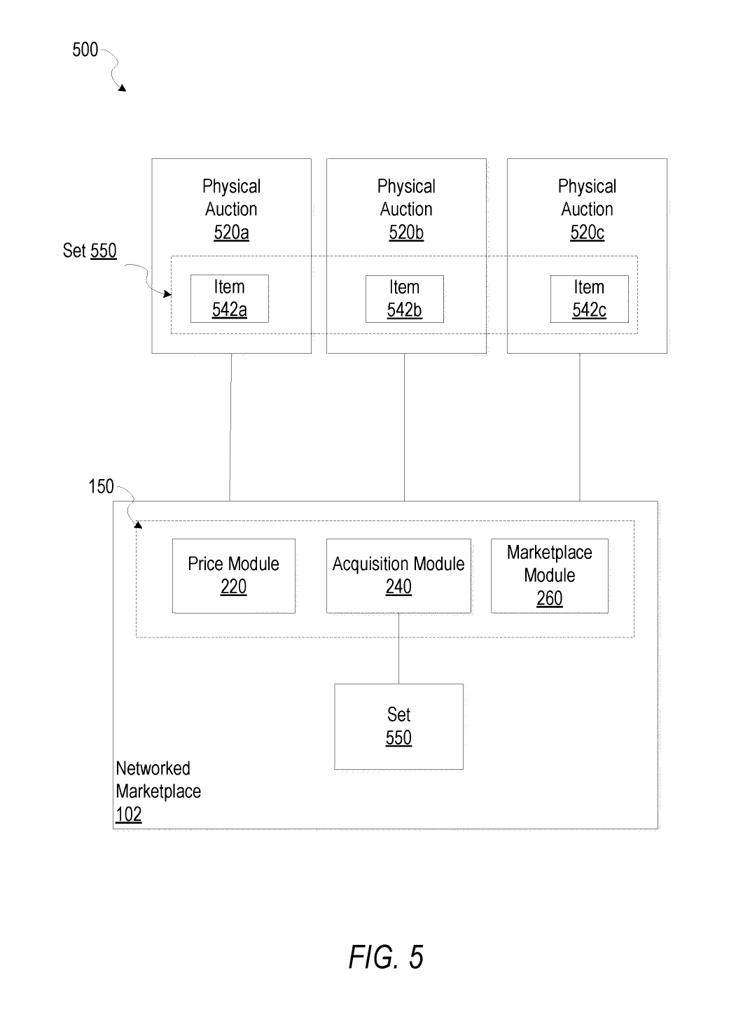

FIG. 5 is a diagram illustrating combining multiple items into a single set for relisting in a networked marketplace 102. According to this embodiment, the relisting system 150 acquires items 542 from separate physical auctions 520 and creates a listing for the set of items 550 at the networked marketplace 102, as described herein

In one example embodiment, three separate and distinct physical auctions 520 have respective items 542 for auction. Physical auction 520a has item 542a, physical auction 520b has item 542b, and physical auction 520c has item 542c. In this example, the physical auctions 520 are located at physically separate locations, but of course, this disclosure is not limited in this regard.

In this example, the price module 220 determines an estimated price for the set 550 of items based on a number of threshold bids for the set exceeding the estimated price as previously described. For example, the price module 220 estimates a price for item 542a, a price for 542b, and a price for item 542c. The price module 220 then adds the respective prices together resulting in a single sum representing the values of the items 542. The price module 220 may then determine a price for the set of items 550 at the networked marketplace 102 as described herein. In response to the price estimate for the set 550 being higher than the summed price estimate of the respective items, the price module 220 may proportionally increase the respective prices of the individual items 542.

For example, where the price estimate for item 542a is $100, the price estimate for item 542b is $150, and the price estimate for the item 542c is $200, the summed price estimate is $450. The price module 220 may then determine that the estimated price for the set 550 of items 542 is $500, which is approximately 10% higher than the summed price of the items 542. Accordingly, the price module 220 may increase the individual price estimates for the individual items 542 by 10%. This results in, according to this specific example, a price estimate for the first item 542a of $110, a price estimate for the second item 542b of $165, and a price estimate for the third item 542c of $220.

The acquisition module 240 then directs purchase of the individual items 542 up to the threshold percentage below the respective price estimates as previously described, and the marketplace module 260 lists the set 550 of items at the networked marketplace 102.

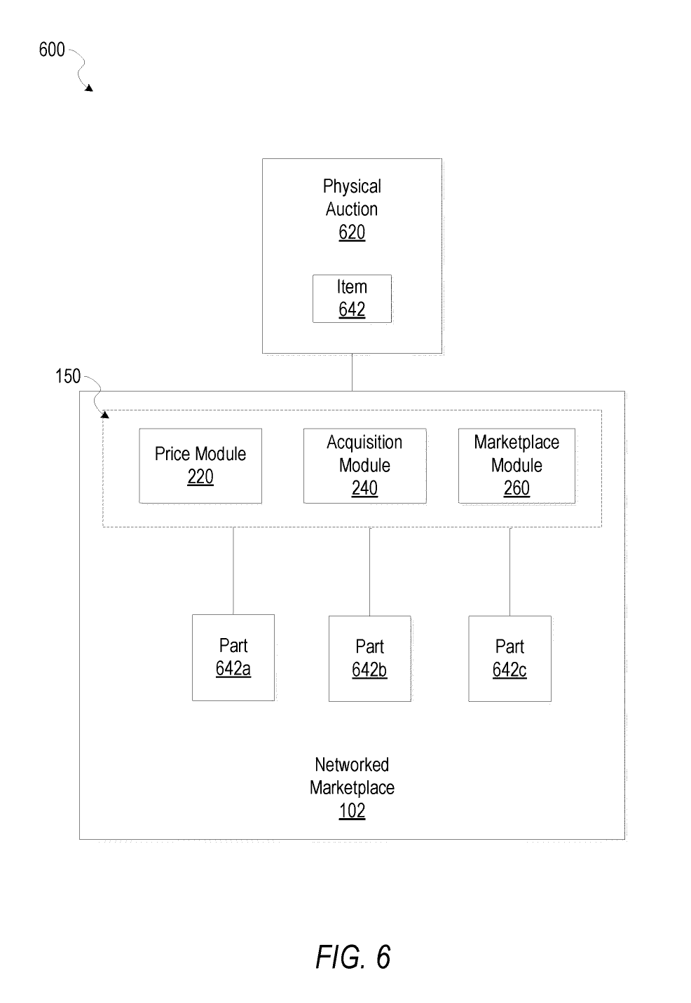

FIG. 6 is a diagram illustrating an example scenario, according to one embodiment. According to this embodiment, the system 150 acquires item 642 from the physical auction 620 and creates a listing for distinct identifiable parts (e.g. 642a, 642b, and 642c) that are part of the item 642.

In one example embodiment, price module 220 estimates a price that the respective parts 642a, 642b, and 642c will sell for at the networked marketplace 102 and sums the prices of the respective parts 642 a-c to determine an estimated price for the item 642.

In this example, the price module 220 determines an estimated price for each of the parts 642a, 642b, 642c based on a number of threshold bids for each part exceeding the estimated price as previously described. For example, where the price estimate for part 642a is $150, the price estimate for part 642b is $200, and the price estimate for the part 642c is $250, the summed price estimate is $600. The price module 220 may then determine that the estimated price for the item 642 is $600. The acquisition module 240 then directs purchase of the item 642 up to a threshold percentage below the price estimate, as previously described, and the marketplace module 260 lists the distinct identifiable parts (642a, 642b, and 642c) at the networked marketplace 102.

In another example, the item 642 includes a collection of baseball cards and the price module 220 determines an estimated price for the collection based on respective price estimates, at the networked marketplace 102, for each of the cards in the collection. The marketplace module 260 then creates respective listings for each of the cards in the collection.

FIG. 7 illustrates a plot indicating a relationship between the number of bids on an item over a period of time to estimate price, according to some examples. In one example embodiment, the price module 220 determines a price for an item based on a pattern of bids for a like item at the networked marketplace 102. In this example, a high number of bids 720 occurred within a most recent 10% of a time period for the auction. According to certain scenarios, an increasing number of bids per unit time for an item at the networked marketplace 102 indicates increased interest in the item, whereas a decreasing number of bids per unit time indicates decreased interest. In this example, the price module 220 determines a price estimate based on a current bid value of the auction at the time corresponding to the time when the highest number of bids 720 were received.

In one example, a highest bid for an item at the networked marketplace 102 was $120, however, a highest number of bids were received at a time when the current bid for the item was $100. Therefore, the price module 220 determines that the price estimate for the item is $100 in response to the number of bids 720 being received at the time associated with the number of bids 720 being above a threshold number.

FIG. 8 illustrates a relationship between the number of bidders 480 on an item and the price of the item, according to some examples. In an embodiment, the price estimate can be based on one or more pricing parameters. In an example, pricing parameters can include, but are not limited to, a threshold number of bids at a price. In an example, the threshold number of bids can be a predefined or user-selected number of bids on an item or a similar item in a networked marketplace 102.

For example, the threshold number of bids can be selected as “40,” and the price module 220 determines that the estimated price is at the point 840 because more than 40 bids were received at that price point 840. In another example, a threshold number of bids is 80 and the price module 220 determines that the estimated price is at the point 820 because more than 80 bids were received at that price point 820. Of course, other price points may be used and this disclosure is not limited in this regard.

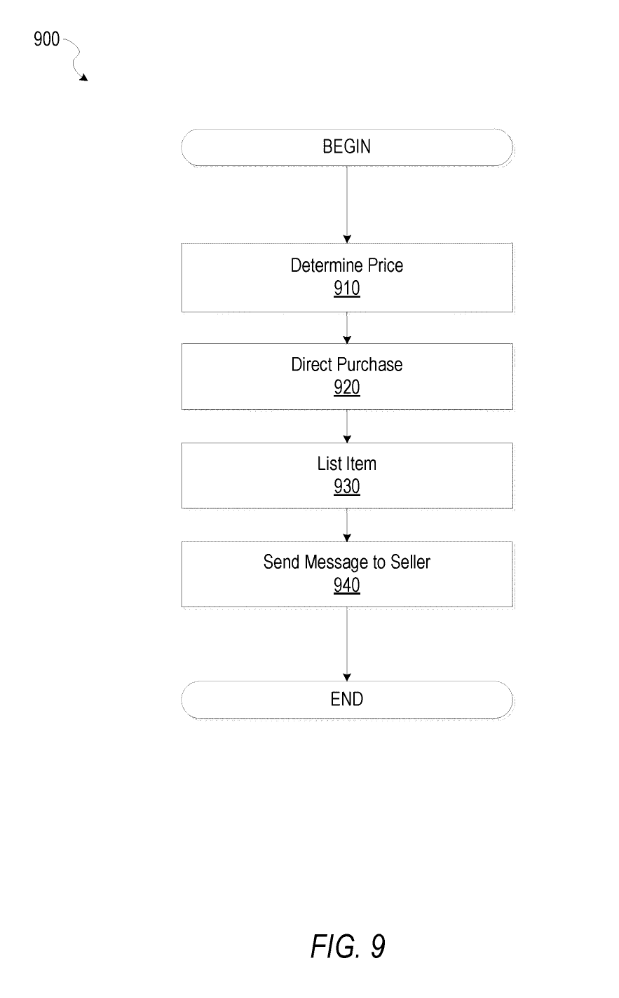

FIG. 9 is a flow diagram illustrating an example of a method, according to one example embodiment. According to one example embodiment, operations in the method 900 may be performed by the system 150, using modules described above with respect to FIGS. 2, 4-6. As shown in FIG. 9, the method 900 includes operations 910, 920, 930, and 940.

In one example, the method 900 begins at operation 910, the price module 220 determines a price estimate that an item will sell for at a networked marketplace 102. The item may be available at a remote auction 250. The price module 220 may also compare a condition of the item with a condition of a like item at the networked marketplace 102.

The method 900 continues at operation 920 and the acquisition module 240 directs purchase of the item at the remote auction 250 by displaying a maximum purchase price to a user 106 at the remote auction 250, the maximum purchase price being a threshold percentage below the price estimate. The method 900 continues at operation 930 and the marketplace module 260 lists the item in a listing at the networked marketplace 102 in response to receiving an indicator indicating that the user 106 won the remote auction 250, a listing price being at or above the price estimate.

The method 900 continues at operation 940 where the marketplace module 260 sends a message to the seller of the item, in response to a purchaser purchasing the item at the networked marketplace 102. The message directs the seller to ship the item to the purchaser of the item at the networked marketplace 102.

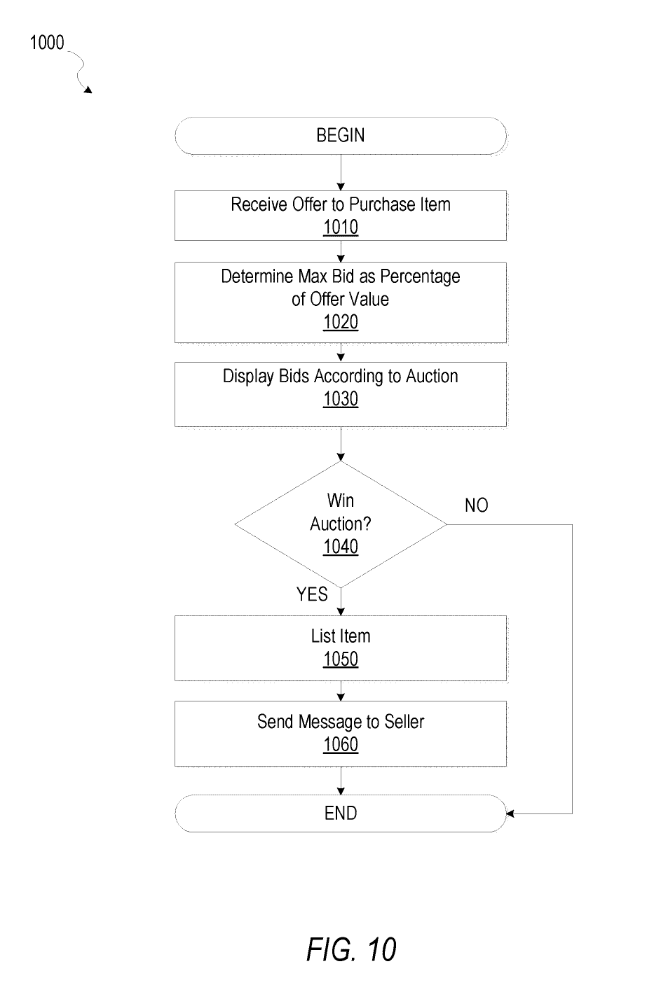

FIG. 10 is a flow diagram illustrating an example of a second method of the profit taking system 105, according to some example embodiments. According to one example embodiment, operations in the method 1000 may be performed by the relisting system 150, using modules described above with respect to FIGS. 2, 4-6. As shown in FIG. 10, the method 1000 includes operations 1010, 1020, 1030, 1040, 1050, 1060.

In one example, the method 1000 begins and at operation 1010, the price module 220 receives an offer to purchase the item 242. The method 1000 continues at operation 1020 where the acquisition module 240 directs purchase of the item 242 at the remote auction 250 by displaying a maximum purchase price to a user 106 at the remote auction 250 with the maximum purchase price being a threshold percentage below the value of the offer received at operation 1010.

The method 1000 continues at operation 1030 where the acquisition module 240 directs the purchase of an item 242 by displaying a bid using a display 404 at the remote auction 250. In an example, the bid is above a current bid for the item 242 and below the maximum purchase price.

The method 1000 continues at operation 1040 where the relisting system 150 receives an indicator indicating whether the relisting system 150 won the auction. In response to the relisting system 150 not winning the auction, the method 1000 ends. In response to the relisting system 150 winning the auction, the method 1000 continues at operation 1050.

At operation 1050, the relisting system 150 lists the item 242 in a listing at the networked marketplace 102. In one embodiment, a listing price is above the price estimate. The method 1000 continues at operation 1060 where the relisting system 150 sends a message in response to a purchaser purchasing the item 242 at the networked marketplace 102, a message to a seller of the remote auction 250, the message directing the seller to ship the item 242 to the purchaser and the method 1000 ends.

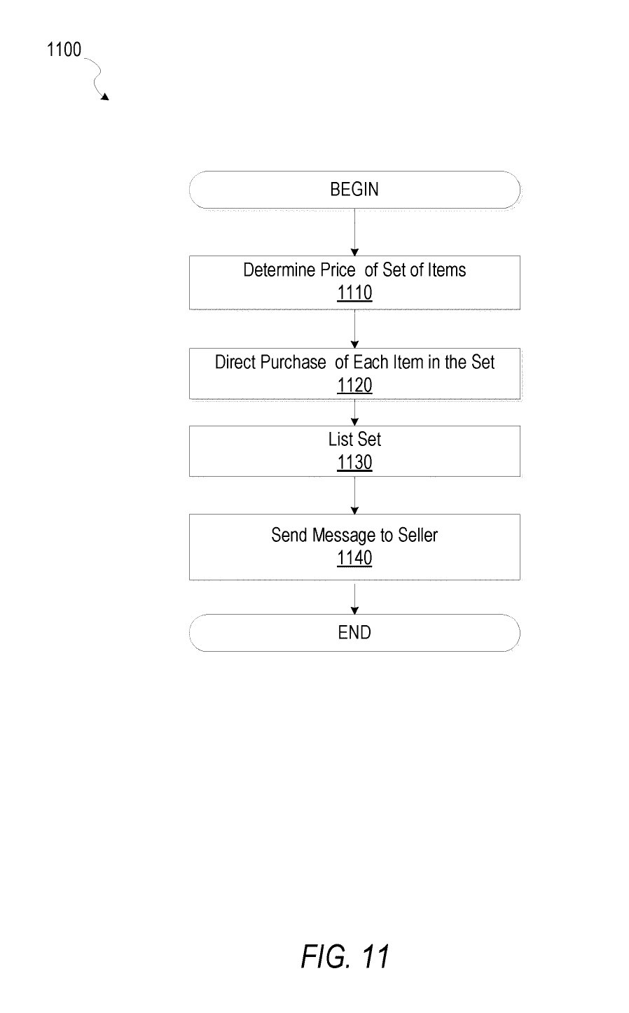

FIG. 11 is a flow diagram illustrating an example of a third method of the relisting system 150, according to some example embodiments. According to one example embodiment, operations in the method 1100 may be performed by the relisting system 150, using modules described above with respect to FIGS. 2, 4-6. As shown in FIG. 11, the method 1100 includes operations 1110, 1120, 1130, and 1140.

In one example, the process 1100 begins at operation 1110, where the price module 220 can determine a price estimate for a set of items by estimating respective prices for items in the set. The process 1100 continues at operation 1120 where the acquisition module 240 can direct the purchase of each item in the set of items. In another embodiment, the acquisition module 240 may verify that each item in the set will be available for purchase before purchasing any of the items in the set. The process 1100 continues at operation 1130 where the marketplace module 260 lists the set in a single listing at the networked marketplace 102.

The method 1100 continues at operation 1140 where the marketplace module 260 sends a message to the seller of the item 242. The message to the seller directs the seller to ship the item 242 to a purchaser of the item 242 at the networked marketplace 102.

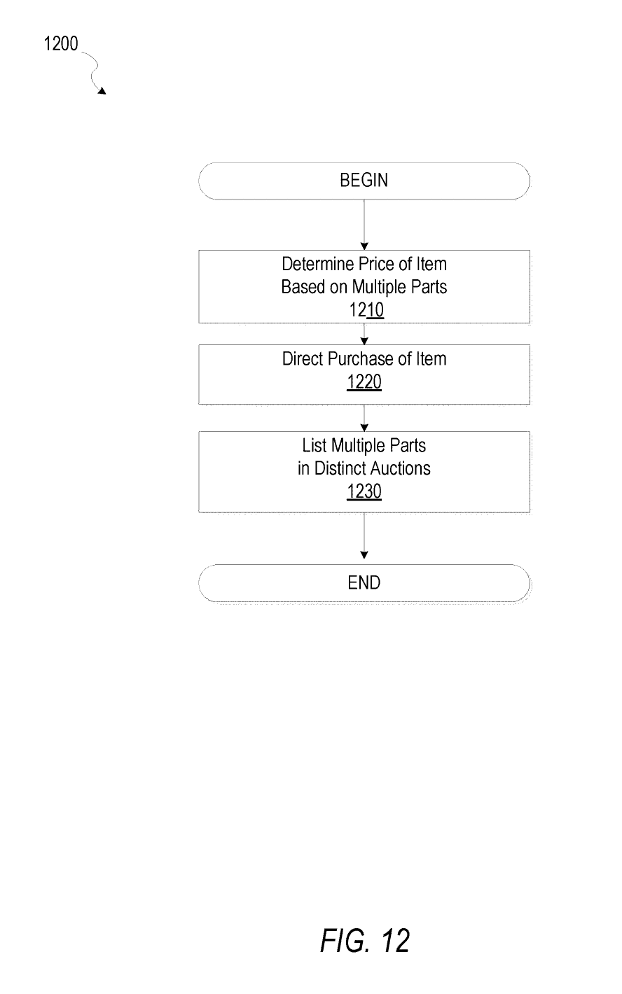

FIG. 12 is a flow diagram illustrating an example of a method 1200 of the relisting system 150, according to some example embodiments. According to one example embodiment, operations in the method 1200 may be performed by the system 150, using modules described above with respect to FIGS. 2, 4-6. As shown in FIG. 12, the method 1200 includes operations 1210, 1220, and 1230.

In one example, the process 1200 begins at operation 1210, where the price module 220 determines a price estimate for an item 242 that includes multiple distinct and identifiable parts by estimating prices for each of the parts. In this embodiment, the price estimate is a sum of the respective price estimates of the distinct parts.

The process 1200 continues at operation 1220 where the acquisition module 240 directs purchase of the item 242 by displaying a bid for the item at a physical auction 620 as previously described. The process 1200 continues at operation 1230 where the marketplace module 260 lists the distinct and identifiable parts of the item 242 in separate listings at the networked marketplace 102.

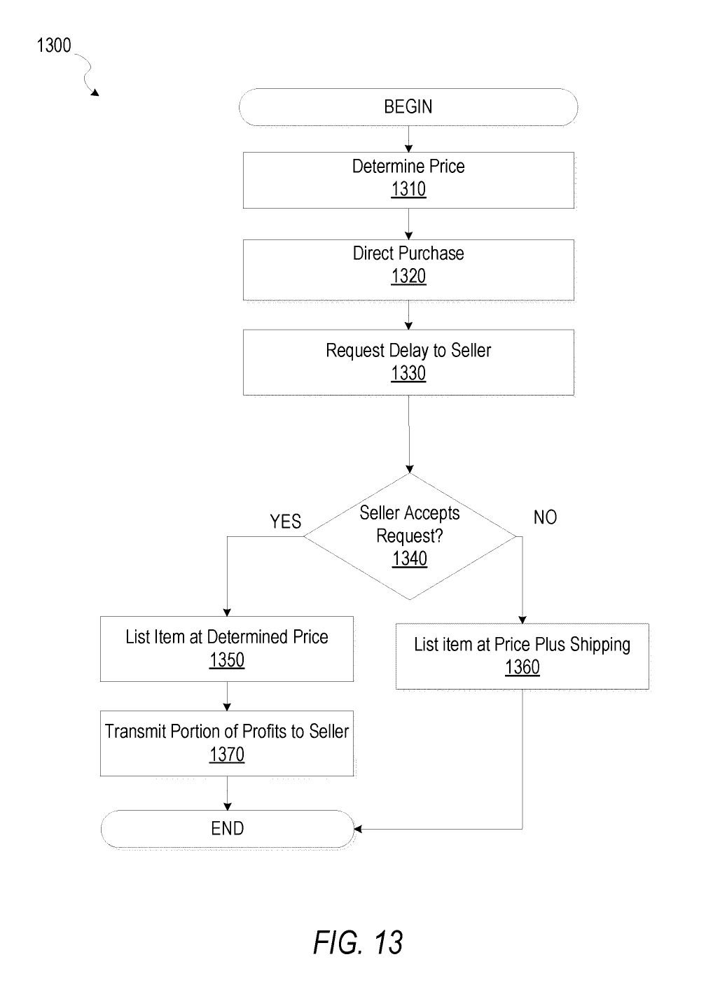

FIG. 13 is a flow diagram illustrating an example of a fifth process of the relisting system 150, according to some example embodiments. According to one example embodiment, operations in the method 1300 are performed by the relisting system 150, using modules described above with respect to FIGS. 2, 4-6. As shown in FIG. 13, the method 1300 includes operations 1310, 1320, 1330, 1340, 1350, 1360, and 1370.

In one example, the method 1300 begins and at operation 1310, the price module 220 determines a price estimate that an item 242 will sell for at a networked marketplace 102 as described herein. In this embodiment, the price estimate is based on a condition of the item 242 matching a condition of a like item at the networked marketplace 102.

The method 1300 continues at operation 1320 and the acquisition module 240 directs purchase of the item at the remote auction 250 by displaying a maximum purchase price to a user 106 at the remote auction 250, the maximum purchase price being a threshold percentage below the price estimate. The method 1300 continues at operation 1330 where the marketplace module 260 requests that the seller of the remote auction 250 delay transferring possession of the item 342 until the listing completes.

The method 1300 continues at operation 1340 where the marketplace module 260 receives an indicator from the user 106 indicating whether the seller accepts. In response to the seller not accepting the request, the method continues at operation 1360. At operation 1360, the marketplace module 260 lists the item 242 at the networked marketplace 102 and includes a shipping cost to ship the item 242. Because the seller will not delay transferring possession of the item 242, the user 106 would typically be required to pay to transfer possession of the item 242. These costs may include shipping the item, or other costs associated with transferring possession of an item. These costs affect the profit margin for the item 242.

In response to the seller agreeing to delay transferring possession of the item 242, the marketplace module 260, at operation 1350, lists the item 242 at the networked marketplace 102 but does not include the extra shipping costs to transfer the item 242 from the seller of the item 242 at the physical marketplace to the user 106.

The method 1300 continues at operation 1370 where the marketplace module 260 transmits a portion of profits resulting from the sale of the item 242 at the networked marketplace 102 to the seller. In this way, a seller of goods at a physical auction 620 further profits from allowing the user 106 to delay transferring possession of the item 242 until the item 242 is resold at the networked marketplace 102.

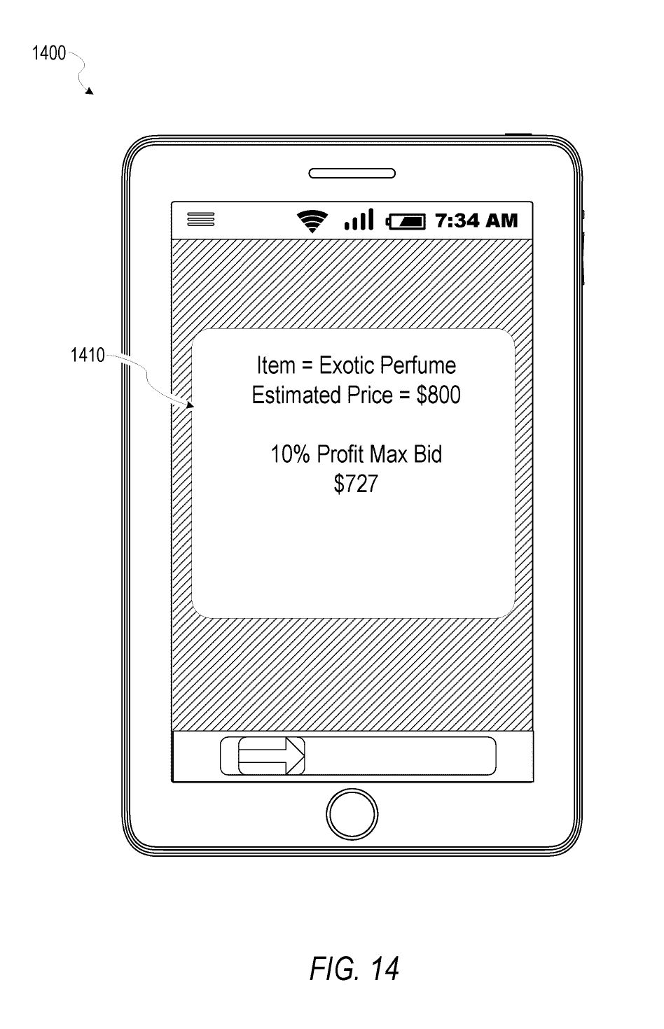

FIG. 14 is a diagram illustrating an example user interface 1410 on a personal electronic device, according to an example embodiment. In this example, the acquisition module 240 displays an estimated price for an item 242 for sale at a physical auction 620, a profit threshold percentage, and a maximum bid for the item 242 that will ensure 10% profits when the item 242 is resold at the networked marketplace 102. Of course, other configurations of user interface elements may be used and this disclosure is not limited in this regard.

In another embodiment, the user interface 1410 displays a bid for an item 242 at a physical auction 620 as described herein. Of course, the user interface 1410 may display other related information, such as, but not limited to, an image of the item 242, a title, other descriptors, other auction related information, or the like.

### Machine and Software Architecture

The modules, methods, applications and so forth described in conjunction with FIGS. 2, 4-6 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Software Architecture

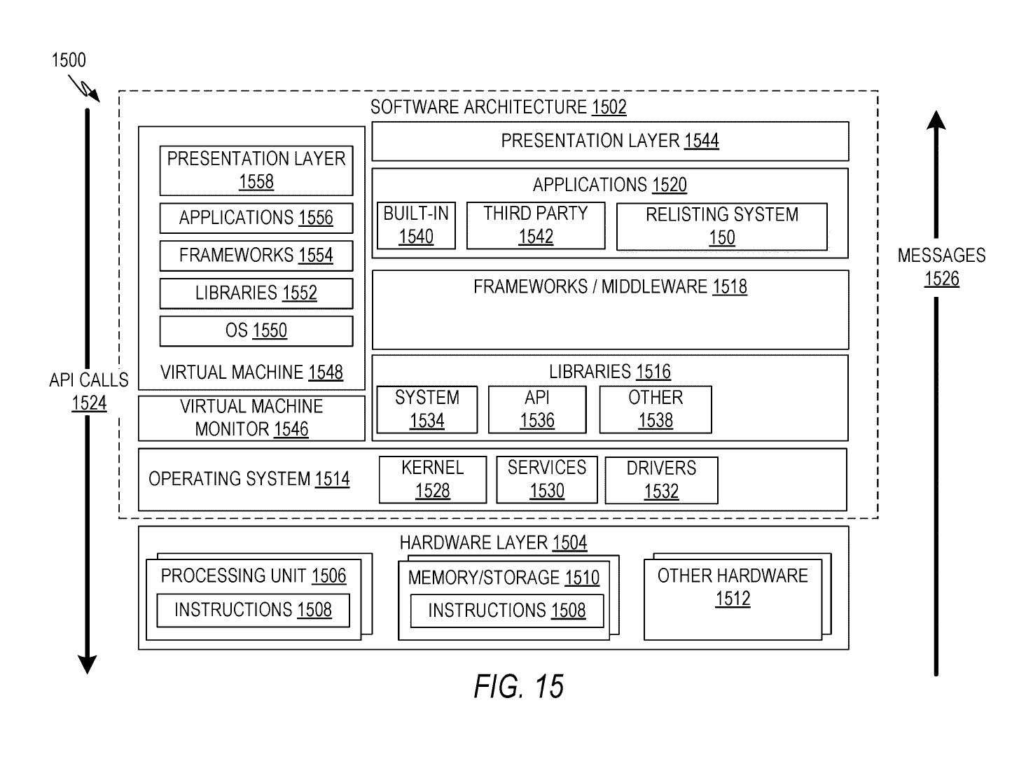

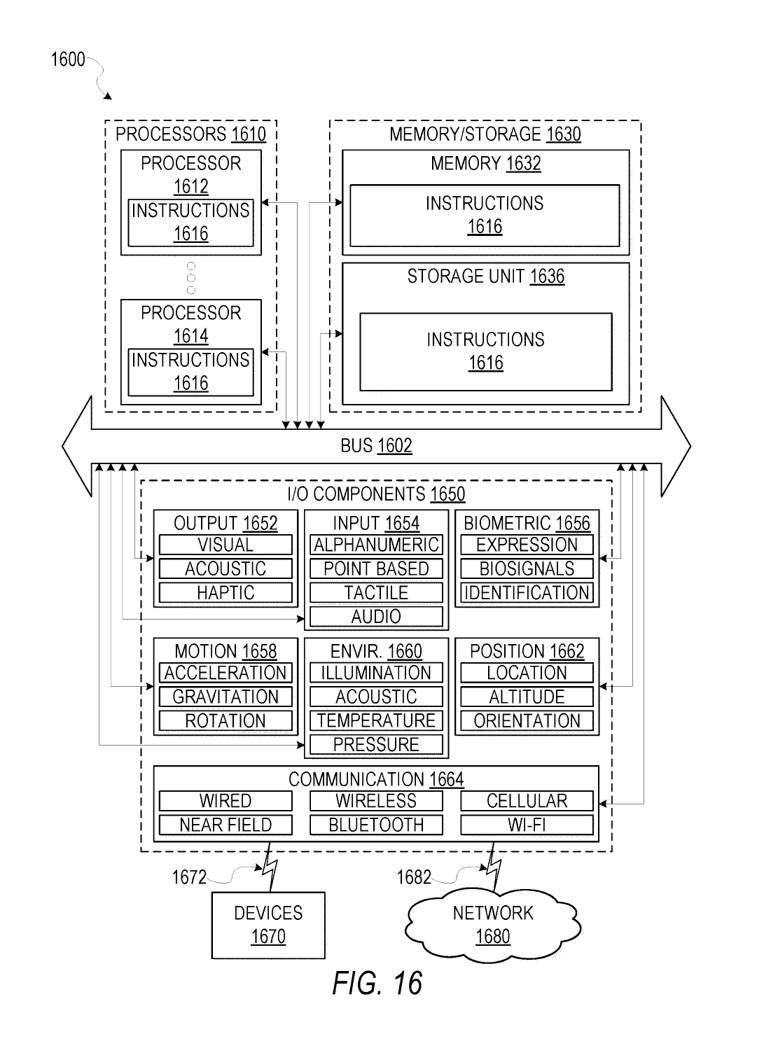

FIG. 15 is a block diagram 1500 illustrating a representative software architecture 1502, which may be used in conjunction with various hardware architectures herein described. FIG. 15 is merely a non-limiting example of a software architecture 1502 and it will be appreciated that many other architectures may be implemented to facilitate the functionality described herein. The software architecture 1502 may be executing on hardware such as machine 1600 of FIG. 16 that includes, among other things, processors 1610, memory 1630, and I/O components 1650. A representative hardware layer 1504 is illustrated and can represent, for example, the machine 1600 of FIG. 16. The representative hardware layer 1504 comprises one or more processing units 1506 having associated executable instructions 1508. Executable instructions 1508 represent the executable instructions of the software architecture 1502, including implementation of the methods, modules and so forth of FIGS. 2, 4-6. Hardware layer 1504 also includes memory and/or storage modules 1510, which also have executable instructions 1508. Hardware layer 1504 may also comprise other hardware as indicated by 1512 which represents any other hardware of the hardware layer 1504, such as the other hardware illustrated as part of machine 1600.

In the example architecture of FIG. 15, the software 1502 may be conceptualized as a stack of layers where each layer provides particular functionality. For example, the software 1502 may include layers such as an operating system 1514, libraries 1516, frameworks/middleware 1518, applications 1520 and presentation layer 1544. Operationally, the applications 1520 and/or other components within the layers may invoke application programming interface (API) calls 1524 through the software stack and receive a response, returned values, and so forth illustrated as messages 1526 in response to the API calls 1524. The layers illustrated are representative in nature and not all software architectures have all layers. For example, some mobile or special purpose operating systems may not provide a frameworks/middleware layer 1518, while others may provide such a layer. Other software architectures may include additional or different layers.

The operating system 1514 may manage hardware resources and provide common services. The operating system 1514 may include, for example, a kernel 1528, services 1530, and drivers 1532. The kernel 1528 may act as an abstraction layer between the hardware and the other software layers. For example, the kernel 1528 may be responsible for memory management, processor management (e.g., scheduling), component management, networking, security settings, and so on. The services 1530 may provide other common services for the other software layers. The drivers 1532 may be responsible for controlling or interfacing with the underlying hardware. For instance, the drivers 1532 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 1516 may provide a common infrastructure that may be utilized by the applications 1520 and/or other components and/or layers. The libraries 1516 typically provide functionality that allows other software modules to perform tasks in an easier fashion than to interface directly with the underlying operating system 1514 functionality (e.g., kernel 1528, services 1530 and/or drivers 1532). The libraries 1516 may include system 1534 libraries (e.g., C standard library) that may provide functions such as memory allocation functions, string manipulation functions, mathematic functions, and the like. In addition, the libraries 1516 may include API libraries 1536 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1516 may also include a wide variety of other libraries 1538 to provide many other APIs to the applications 1520 and other software components/modules.

The frameworks 1518 (also sometimes referred to as middleware) may provide a higher-level common infrastructure that may be utilized by the applications 1520 and/or other software components/modules. For example, the frameworks 1518 may provide various graphic user interface (GUI) functions, high-level resource management, high-level location services, and so forth. The frameworks 1518 may provide a broad spectrum of other APIs that may be utilized by the applications 1520 and/or other software components/modules, some of which may be specific to a particular operating system 1514 or platform.

The applications 1520 include built-in applications 1540 and/or third party applications 1542. Examples of representative built-in applications 1540 may include, but are not limited to, a contacts application, a browser application, a book reader application, a location application, a media application, a messaging application, and/or a game application. Third party applications 1542 may include any of the built in applications as well as a broad assortment of other applications. In a specific example, the third party application 1542 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1542 may invoke the API calls 1524 provided by the mobile operating system such as operating system 1514 to facilitate functionality described herein.

In another embodiment, the various modules described herein (e.g. the price module 220, the acquisition module 240, and the marketplace module 260) are implemented as an application 1520. In this example, the modules are implemented as executable code and may communicate with one or more frameworks/middleware 1518 and/or one or more libraries 1516 as one skilled in the art may appreciate. Therefore, a user 106 may execute the relisting system 150 causing the various modules to perform their respective functions as described herein.

The applications 1520 may utilize built in operating system functions (e.g., kernel 1528, services 1530 and/or drivers 1532), libraries (e.g., system 1534, APIs 1536, and other libraries 1538), frameworks/middleware 1518 to create user interfaces 1410 to interact with users 106 of the system. Alternatively, or additionally, in some systems, interactions with a user 106 may occur through a presentation layer, such as presentation layer 1544. In these systems, the application/module “logic” can be separated from the aspects of the application/module that interact with a user 106.

In one specific example, the relisting system 150 communicates with a library to retrieve specific item parameters. For example, in response to receiving a part number from the physical auction, the relisting system 150 requests complete information regarding the item based, at least in part, on the part number.

Some software architectures utilize virtual machines. In the example of FIG. 15, this is illustrated by virtual machine 1548. A virtual machine 1548 creates a software environment where applications/modules can execute as if they were executing on a hardware machine (such as the machine 1600 of FIG. 16, for example). A virtual machine 1548 is hosted by a host operating system (operating system 1514 in FIG. 16) and typically, although not always, has a virtual machine monitor 1546, which manages the operation of the virtual machine 1548 as well as the interface with the host operating system (i.e., operating system 1514). A software architecture executes within the virtual machine 1548 such as an operating system 1550, libraries 1552, frameworks/middleware 1554, applications 1556 and/or presentation layer 1558. These layers of software architecture executing within the virtual machine 1548 can be the same as corresponding layers previously described or may be different.

### Example Machine Architecture and Machine-Readable Medium

FIG. 16 is a block diagram illustrating components of a machine 1600, according to some example embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system, within which instructions 1616 (e.g., software, a program, an application 1520, an applet, an app, or other executable code) for causing the machine 1600 to perform any one or more of the methodologies discussed herein may be executed. For example, the instructions 1616 may cause the machine 1600 to execute the flow diagrams of FIGS. 9-13. Additionally, or alternatively, the instructions 1616 may implement the price module 220, the acquisition module 240, and the marketplace module 260 of FIGS. 2, 4-6, and so forth. The instructions 1616 transform the general, non-programmed machine 1600 into a particular machine programmed to carry out the described and illustrated functions in the manner described. In alternative embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1616, sequentially or otherwise, that specify actions to be taken by machine 1600. Further, while only a single machine 1600 is illustrated, the term “machine” shall also be taken to include a collection of machines 1600 that individually or jointly execute the instructions 1616 to perform any one or more of the methodologies discussed herein.

The machine 1600 may include processors 1610, memory 1630, and I/O components 1650, which may be configured to communicate with each other such as via a bus 1602. In an example embodiment, the processors 1610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1612 and processor 1614 that may execute instructions 1616. The term “processor” is intended to include multi-core processor that may comprise two or more independent processors (sometimes referred to as “cores”) that may execute instructions contemporaneously. Although FIG. 16 shows multiple processors, the machine 1600 may include a single processor with a single core, a single processor with multiple cores (e.g., a multi-core process), multiple processors with a single core, multiple processors with multiples cores, or any combination thereof.

The memory/storage 1630 may include a memory 1632, such as a main memory, or other memory storage, and a storage unit 1636, both accessible to the processors 1610 such as via the bus 1602. The storage unit 1636 and memory 1632 store the instructions 1616 embodying any one or more of the methodologies or functions described herein. The instructions 1616 may also reside, completely or partially, within the memory 1632, within the storage unit 1636, within at least one of the processors 1610 (e.g., within the processor's cache memory), or any suitable combination thereof, during execution thereof by the machine 1600. Accordingly, the memory 1632, the storage unit 1636, and the memory of processors 1610 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1616. The term “machine-readable medium” shall also be taken to include any medium, or combination of multiple media, that is capable of storing instructions (e.g., instructions 1616) for execution by a machine (e.g., machine 1600), such that the instructions, when executed by one or more processors of the machine 1600 (e.g., processors 1610), cause the machine 1600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1650 may include a wide variety of components to receive input, provide output, produce output, transmit information, exchange information, capture measurements, and so on. The specific I/O components 1650 that are included in a particular machine will depend on the type of machine. For example, portable machines such as mobile phones will likely include a touch input device or other such input mechanisms, while a headless server machine will likely not include such a touch input device. It will be appreciated that the I/O components 1650 may include many other components that are not shown in FIG. 16. The I/O components 1650 are grouped according to functionality merely for simplifying the following discussion and the grouping is in no way limiting. In various example embodiments, the I/O components 1650 may include output components 1652 and input components 1654. The output components 1652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. In one specific example, an output component 1652 includes the bid display 404. The input components 1654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1650 may include biometric components 1656, motion components 1658, environmental components 1660, or position components 1662 among a wide array of other components. For example, the biometric components 1656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1658 may include acceleration sensor components (e.g., accelerometer), gravitation sensor components, rotation sensor components (e.g., gyroscope), and so forth. The environmental components 1660 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1650 may include communication components 1664 operable to couple the machine 1600 to a network 1680 or devices 1670 via coupling 1682 and coupling 1672 respectively. For example, the communication components 1664 may include a network interface component or other suitable device to interface with the network 1680. In further examples, communication components 1664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1670 may be another machine or any of a wide variety of peripheral devices (e.g., a peripheral device coupled via a Universal Serial Bus (USB)).

Moreover, the communication components 1664 may detect identifiers or include components operable to detect identifiers. For example, the communication components 1664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1664, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1680 or a portion of the network 1680 may include a wireless or cellular network and the coupling 1682 may be a Code Division Multiple Access (CDMA) connection, a Global System for Mobile communications (GSM) connection, or other type of cellular or wireless coupling. In this example, the coupling 1682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1616 may be transmitted or received over the network 1680 using a transmission medium via a network interface device (e.g., a network interface component included in the communication components 1664) and utilizing any one of a number of well-known transfer protocols (e.g., hypertext transfer protocol (HTTP)). Similarly, the instructions 1616 may be transmitted or received using a transmission medium via the coupling 1672 (e.g., a peer-to-peer coupling) to devices 1670. The term “transmission medium” shall be taken to include any intangible medium that is capable of storing, encoding, or carrying instructions 1616 for execution by the machine 1600, and includes digital or analog communications signals or other intangible medium to facilitate communication of such software.

In one specific example, the price module 220 communicates with the networked marketplace 102 over the one or more of the communication components 1664. Furthermore, the acquisition module 240 may communicate with an electronic interface for a remote physical auction 620 over one or more of the communication components 1664.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A computer system comprising:
a processor;
a memory device holding an instruction set executable on the processor to cause the computer system to perform operations comprising:
determining, by communicating via an electronic interface to a networked marketplace, a price estimate that an item will sell for at the networked marketplace, the item available at a remote auction, the price estimate based on a similar item at the networked marketplace receiving a threshold number of bids above the price estimate, the price estimate further based on an item condition, the item condition selected from a set of predefined conditions;
directing purchase of the item at the remote auction by electronically displaying a purchase price at the remote auction, the purchase price being a threshold percentage below the price estimate;
listing the item in a listing at the networked marketplace using information about the item received from the electronic interface and in response to winning the remote auction, a listing price being at or above the price estimate; and
sending, in response to a purchaser purchasing the item at the networked marketplace, a message to a seller of the remote auction, the message directing the seller to ship the item to the purchaser.

2. The computer system of claim 1, wherein directing purchase of the item at the remote auction comprises displaying a bid using a display at the remote auction.

3. The computer system of claim 1, wherein the price estimate is further based on a value of an offer to purchase the item, the offer received from a buyer at the networked marketplace.

4. The computer system of claim 1, wherein the operations further comprise requesting that the seller of the remote auction delay transferring possession of the item until the listing completes.

5. The computer system of claim 4, wherein the operations further comprise transmitting a portion of profits resulting from the sale of the item at the networked marketplace to the seller in response to the seller agreeing to delay transferring possession of the item.

6. The computer system of claim 1, wherein determining a price estimate comprises estimating a price for a set of items that includes the item, directing purchase of the item comprises directing purchase of each item in the set, and listing the item comprises listing the set of items in a single listing at the networked marketplace.

7. The computer system of claim 1, wherein the item comprises multiple distinct and identifiable parts, determining a price estimate comprises estimating prices for each of the parts, the price comprises a sum of the prices for the parts, and the listing comprises relisting each of the parts at the networked marketplace.

8. The computer system of claim 1, wherein the item comprises multiple distinct and identifiable parts, determining a price estimate comprises estimating prices for each of the parts, the price comprises a sum of the prices for the parts, and the listing comprises relisting the item at the networked marketplace.

9. A computer-implemented method comprising:
Determining, by communicating via an electronic interface to a networked marketplace, a price estimate that an item will sell for at the networked marketplace, the item available at a remote auction, the price estimate based on a similar item at the networked marketplace receiving a threshold number of bids above the price estimate, the price estimate further based on an item condition, the item condition selected from a set of predefined conditions;
directing purchase of the item at the remote auction by electronically displaying a purchase price at the remote auction, the purchase price being a threshold percentage below the price estimate;
listing the item in a listing at the networked marketplace using information about the item received from the electronic interface and in response to winning the remote auction, a listing price being at or above the price estimate; and
sending, in response to a purchaser purchasing the item at the networked marketplace, a message to a seller of the remote auction, the message directing the seller to ship the item to the purchaser.

10. The computer-implemented method of claim 9, wherein directing purchase of the item at the remote auction comprises displaying a bid using a display at the remote auction.

11. The computer-implemented method of claim 9, wherein the price estimate is further based on a value of an offer to purchase the item, the offer received from a buyer at the networked marketplace.

12. The computer-implemented method of claim 9; wherein the operations further comprise requesting that the seller of the remote auction delay transferring possession of the item until the listing completes.

13. The computer-implemented method of claim 12, wherein the operations further comprise transmitting a portion of profits resulting from the sale of the item at the networked marketplace to the seller in response to the seller agreeing to delay transferring possession of the item.

14. The computer-implemented method of claim 9, wherein determining a price estimate comprises estimating a price for a set of items that includes the item, directing purchase of the item comprises directing purchase of each item in the set, and listing the item comprises listing the set of items in a single listing at the networked marketplace.

15. The computer-implemented method of claim 9, wherein the item comprises multiple distinct and identifiable parts, determining a price estimate comprises estimating prices for each of the parts, the price comprises a sum of the prices for the parts, and the listing comprises relisting each of the parts at the networked marketplace.

16. The computer-implemented method of claim 9, wherein the item comprises multiple distinct and identifiable parts, determining a price estimate comprises estimating prices for each of the parts, the price comprises a sum of the prices for the parts, and the listing comprises relisting the item at the networked marketplace.

17. A machine-readable medium storing executable instructions thereon, which, when executed one or more processors, cause the one or more processors to perform operations including:
determining, by communicating via an electronic interface to a networked marketplace, a price estimate that an item will sell for at the networked marketplace, the item available at a remote auction, the price estimate based on a similar item at the networked marketplace receiving a threshold number of bids above the price estimate, the price estimate further based on an item condition, the item condition selected from a set of predefined conditions;
directing purchase of the item at the remote auction by electronically displaying a purchase price at the remote auction, the maximum purchase price being a threshold percentage below the price estimate;
listing the item in a listing at the networked marketplace using information about the item received from the electronic interface and in response to receiving an indicator indicating that the user on the remote auction, a listing price being at or above the price estimate;
sending, in response to a purchaser purchasing the item at the networked marketplace; a message to a seller of the remote auction, the message directing the seller to ship the item to the purchaser.

18. The machine-readable medium of claim 17, wherein directing purchase of the item at the remote auction comprises displaying a bid using a display at the remote auction.

19. The machine-readable medium of claim 17, wherein the operations further comprise requesting that the seller of the remote auction delay transferring possession of the item until the listing completes.

20. The machine-readable medium of claim 17, wherein the item comprises multiple distinct and identifiable parts, determining a price estimate comprises estimating prices for each of the parts, the price comprises a sum of the prices for the parts, and the listing comprises relisting each of the parts at the networked marketplace.
